(19) United States
(12) Patent Application Publication
(10) Pub. No.: US 2015/0332614 A1
(43) Pub. Date: Nov. 19, 2015

(54) Identi-TAG

(71) Applicant: Glen Rester, Youngsville, LA (US)

(72) Inventor: Glen Rester, Youngsville, LA (US)

(21) Appl. No.: 14/120,403

(22) Filed: May 19, 2014

(51) Int. Cl. G09F 3/00; G09F 3/04

(52) U.S. Cl. CPC G09F 3/0295; G09F 3/04

(57) ABSTRACT

The Identi-TAG uses an existing technology with rubber grips on each end and in the center of the elongated bi-stable ribbon steel. When the ribbon steel is slapped onto a steel or PVC pipe it will automatically wrap itself around the pipe and is held in place by the rubber grips. This saves a pipe manufacturer many thousands of dollars each year by being able to use it hundreds of times instead of once per use.

### BACKGROUND OF THE INVENTION

(1) Field of the Invention

The Identi-TAG is a new invention using existing elongated bi-stable ribbon spring steel with rubber grips.

(2) Description of the Art Including Information Disclosed Under 37 CFR 1.97 & 1.98

The art described in the drawings of the design and utility function illustrate the unique ability of the Identi-TAG invention to use an existing technology as the elongated bi-stable ribbon spring steel with rubber grips on the center portion and both ends. There have been a number of inventions using this existing technology in a different way such as Publication number US2013/0321759 A1 and U.S. Pat. No. 7,347,019 and publication number US 2012/0324945 A1 and there a few others but none of them were similar in the nature to my invention for its specific use. The Identi-TAG uses an existing elongated bi-stable ribbon spring steel technology that is not being patented as it is already public domain however with the rubber grips and the purpose of its use we are patenting those portions of the invention.

### BRIEF SUMMARY OF THE INVENTION

The Identi-TAG invention is a new type of tag used by steel and PVC pipe manufactures. It can be used hundreds of times instead of the plastic tags being used for only one use per tag. It has rubber grips on each end and one in the center to keep the tag in place and makes it easy to attach and remove from the pipe. It will save a lot of time and labor for the manufacturer and will save them huge dollars by not having to purchase the tags and only use them for a one time use. The Identi-TAG can be used hundreds of times while saving the company lots of money and labor that can be used for more productivity.

### BRIEF DESCRIPTION OF THE SEVERAL VIEWS OF THE DRAWINGS

There are 4 drawings in total that describe and illustrate the design and function of the Identi-TAG invention.

FIG. 1: is the ¾ view of the invention.

FIG. 2: is the side view of the invention.

FIG. 3: is the top view of the invention.

FIG. 4: is the bottom view of the invention.

### DETAILED DESCRIPTION OF THE PREFERRED EMBODIMENT

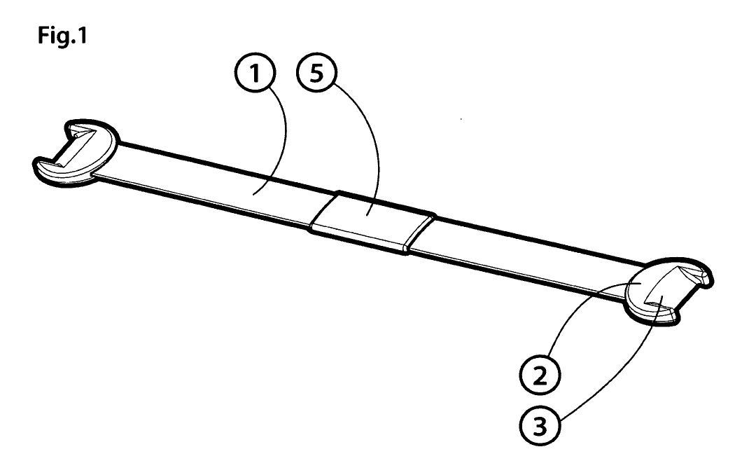

FIG. 1: In this ¾ view illustration #1 shows the main body of the ribbon spring steel with #2 the end rubber grip portion with #3 the angled opening for the ribbon to fit inside of itself with #5 the center rubber grip.

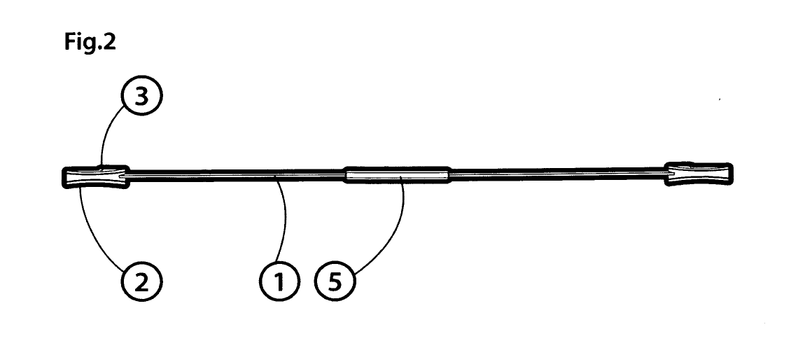

FIG. 2: In this side view illustration #1 shows the main body of the ribbon spring steel with #2 the end rubber grip portion with #3 the angled opening for the ribbon to fit inside of itself with #5 the center rubber grip.

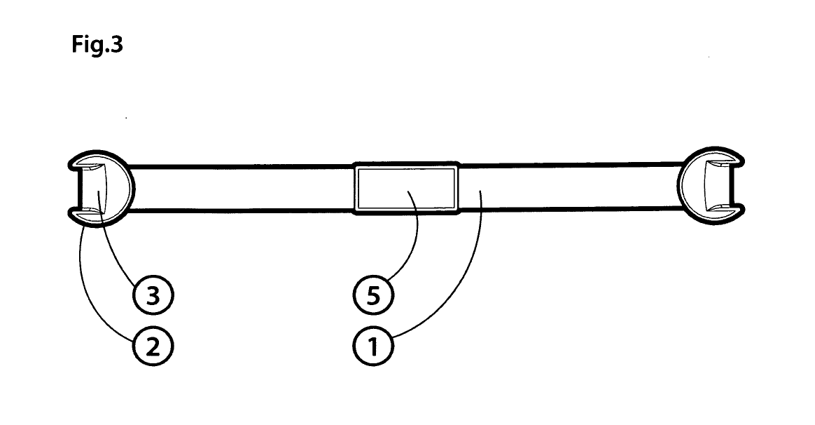

FIG. 3: In this top view illustration #1 shows the main body of the ribbon spring steel with #2 the end rubber grip portion with #3 the angled opening for the ribbon to fit inside of itself with #5 the center rubber grip.

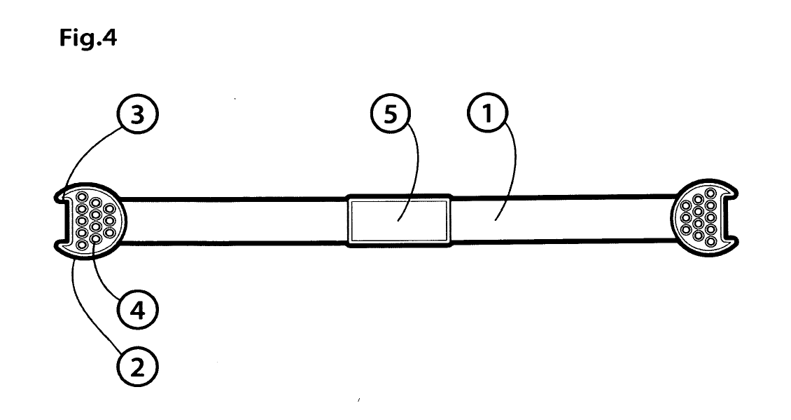

FIG. 4: In this bottom view illustration #1 shows the main body of the ribbon spring steel with #2 the end rubber grip portion with #3 the angled opening for the ribbon to fit inside of itself with #4 the bottom grip portion with the dotted tread with #5 the center rubber grip.

### DETAILED DESCRIPTION OF THE INVENTION

The Identi-TAG is a new tag that replaces existing paper and plastic tags used by steel and PVC pipe manufacturers. When manufacturing pipe there are often times pipe that has irregularities in the construction of the pipe. It has to be tagged to go to a repair department or it may need to be sanded down or it may be need to be sent to another department for painting or other departments for many different reasons. They usually come in different colors and they have printing on them to identify what needs to be done to the pipe. They are made of paper or plastic and they take time to attach to the pipe and to remove from the pipe.

This takes time and labor to do all of this for a simple task. They also can cost about $0.50 per tag and they may use 250,000 tags per year. That is a very big cost to the company all the way around.

With the Identi-TAG you can use it hundreds of times at about $0.001 per use and saves time and labor. It uses an existing technology with an elongated bi-stable ribbon spring steel which when it is in a straight form or position once you slap it on the pipe it automatically wraps around the pipe and holds itself in place. It has strong rubber grips on each end and in the center of the body of the spring steel tag. The rubber grips have a dotted tread on the bottom side which grip onto the pipe and prevent the tag from being moved around from its original position. It can come in many different colors and can be printed on the main body of even the rubber grips. The steel portion of the main body can be painted or can be shrink wrapped or can be dipped in a rubber compound to protect the steel from rusting. The rubber grips can be different shapes and sizes with different tread designs as well. The use of the invention is what is being patented with the unique ability that it has. The Identi-TAG uses an existing technology that is not being patented as it is already public domain however with the rubber grips and the purpose of its use we are patenting those portions of the invention.

What is claimed is:

1. An elongated bi-stable ribbon spring steel member comprising of:
a rubber grip permanently attached on each end of the elongated member;
a rubber grip permanently attached in the center portion of the elongated member;
an opening in the end portion of the rubber grip that allows the elongated member to fit inside of itself when being wrapped around a pipe;
an opening of the end rubber grip with an angle inside of the opening that is angled to a degree that allows the elongated member to lie flat inside the opening of the end rubber grip portion when being wrapped around a pipe;
a tread design on the bottom side of the end rubber grip to prevent it moving from its original position;
an elongated member that can be different lengths or widths to adjust for the diameter or circumference of any pipe size.
